(19) United States
(12) Patent Application Publication
(10) Pub. No.: US 2003/0110752 A1
(43) Pub. Date: Jun. 19, 2003

(54) Guard for crop pick up apparatus

(75) Inventor: Paul W. Dow, Byron, NY (US)

Correspondence Address: Merchant & Gould P.C., P.O. Box 2903, Minneapolis, MN, 55402-0903, US

(73) Assignee: Oxbo International Corporation

(21) Appl. No.: 10/027,930

(22) Filed: Dec. 19, 2001

(51) Int. Cl. A01D 89/00

(52) U.S. Cl. 56/364

(57) ABSTRACT

The present invention is directed to a crop collector, the head on a crop collector and substantially straight elongate guards on the head. The head includes a rotating reel with sets of radially spaced apart tines disposed around an arbor, with the tine sets spaced axially along the reel. The head includes a housing having substantially straight elongate guards, also know as strippers, intermediate adjacent tine sets. The guards are configured for mounting to the crop collector in an arcing configuration. The guards are made of a lightweight flexible plastic type material in one embodiment, such as polyethylene.

### BACKGROUND OF THE INVENTION

The present invention relates to a crop harvesting apparatus, and in particular to straight guards forming a shield for the head, mounted in an arcing configuration under tension.

### PRIOR ART

Harvesters and other pick up devices with a head having a rotating reel are well known and used to pick up a variety of crops such as hay, beans and other crops that are pick up crops near the ground. These pick up devices are self-propelled or often towed by a tractor and have a head that extends generally transversely to the direction of travel to clear a wide swath as the harvester moves over a field. The crop is typically either picked up from a windrow, which has been laid by other machinery, or directly cut from the ground. Such crop harvesting devices generally include a tine reel having a plurality of tines or sets of tines spaced along a transverse axis that engage the crop near the ground and propel it up over the reel and rearward. The crop is delivered from the head to a conveying system, such as a merger, and to a chopper, a re-cutter, a baler or other processing machinery. Some crops, such as hay are baled or chopped further. Other crops are delivered as cut to storage bins on the harvester or to trucks and/or trailers.

Guards, also known as strippers, are spaced intermediate the sets of tines and generally wrap around the majority of the reel. The head may become damaged due to the harvester striking uneven terrain, rocks and other debris in its path. The guards act as a shield and help to direct the crop and other matter to prevent damage to the interior elements of the reel and to maintain a clear material flow path. Prior art devices, such as shown in FIGS. 1-3, extend around the top, front and bottom of the reel and extend rearwardly. The prior guards are metal and in the form of a tight arc, such as shown most clearly in FIGS. 2 and 3. The coiled guards are mounted to the pick up device around the reel. The tightly arced guards are challenging to mount and dismount, especially pulling the guards over the reel and accessing the difficult to reach lower end. As shown in FIG. 2, the metal guards may include flanges along either edge that extend the length of the guard. Problems arise when the metal guards or strippers strike the ground and may become broken, bent or otherwise not flex properly. If the guards are bent or misaligned, they may protrude into the path of adjacent rotating tines, causing further damage. In addition, when the guards break off, they may cause damage downstream as, for example, when they enter an auger or a chopper. In addition, in order to perform maintenance on the reel, such as to replace or adjust a tine, it is necessary to detach and completely remove the guards. With the prior art guard devices, it is necessary to remove both ends and pull the guard outward, generally complicating and adding length to the maintenance operation.

It can be seen, then, that a new and improved crop harvesting apparatus is needed that includes an improved guard. Such a guard should provide easy mounting and easy access to the reel. Such a guard should also provide for improved resilience and less breakage than prior art guards when impacting the ground or being struck by other objects. The present invention addresses these as well as other problems associated with guards for crop harvesting devices.

### SUMMARY OF THE INVENTION

The present invention is directed to a crop collector, the head on a crop collector and elongate flexible guards on the head. The crop collecting head includes a rotating reel with sets of radially spaced apart tines disposed around an arbor, with the tine sets spaced axially along the reel. The head includes a housing having substantially straight elongate guards, also know as strippers, spaced axially along the head intermediate adjacent tine sets. The straight guards are configured for mounting to the crop collector in an arcing configuration around the bottom, front and top of the arbor. Access to the tines and arbor may be accomplished by simply detaching one end of the guards and allowing it to extend outward. In one embodiment, the guards are made of a lightweight flexible plastic type material, such as polyethylene.

The guards or strippers mount to the crop collector by mounting a first end while the elongate member extends outward from the reel. The guard is then flexed into an arcing profile around the front and around the front of the reel, with a second end attached under tension. One end may remain attached while maintenance is performed on the reel, as the straight guard does not wrap around the reel when one of the ends is detached.

These features of novelty and various other advantages that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the present invention.

### BRIEF DESCRIPTION OF THE DRAWINGS

Referring now to the drawings, wherein like reference letters and numerals indicate corresponding structure throughout the several views:

FIG. 1 is a perspective view of a reel for a crop collecting apparatus with prior art guards;

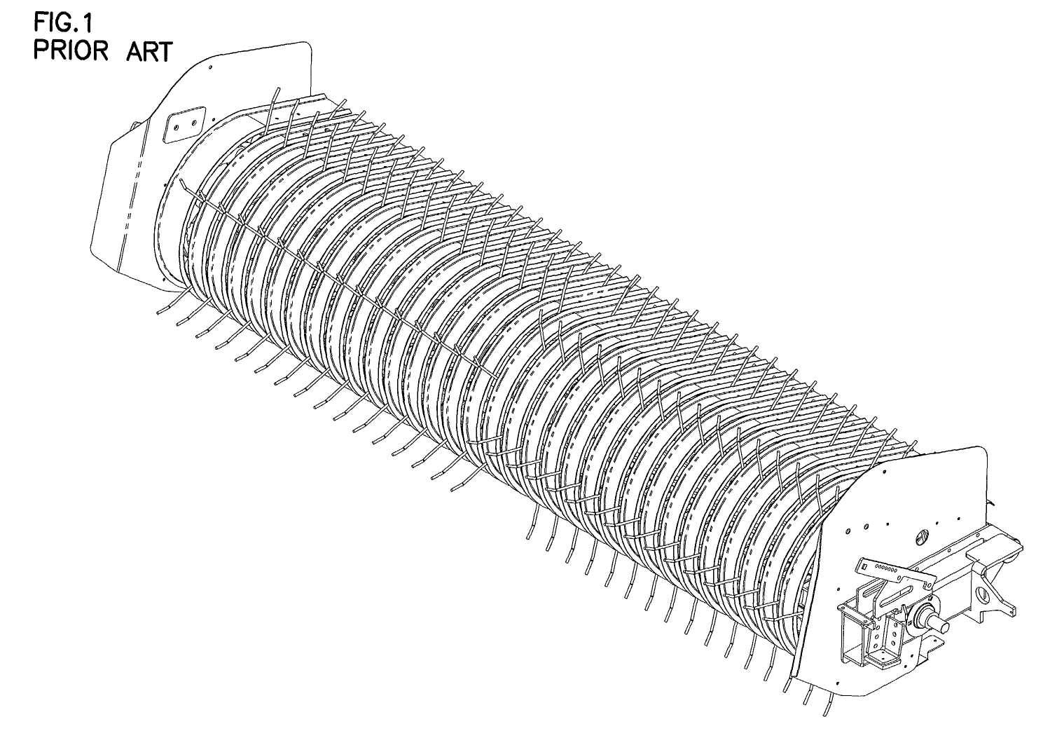

FIG. 2 is a detail perspective view of a portion of the reel shown in FIG. 1 with several guards removed;

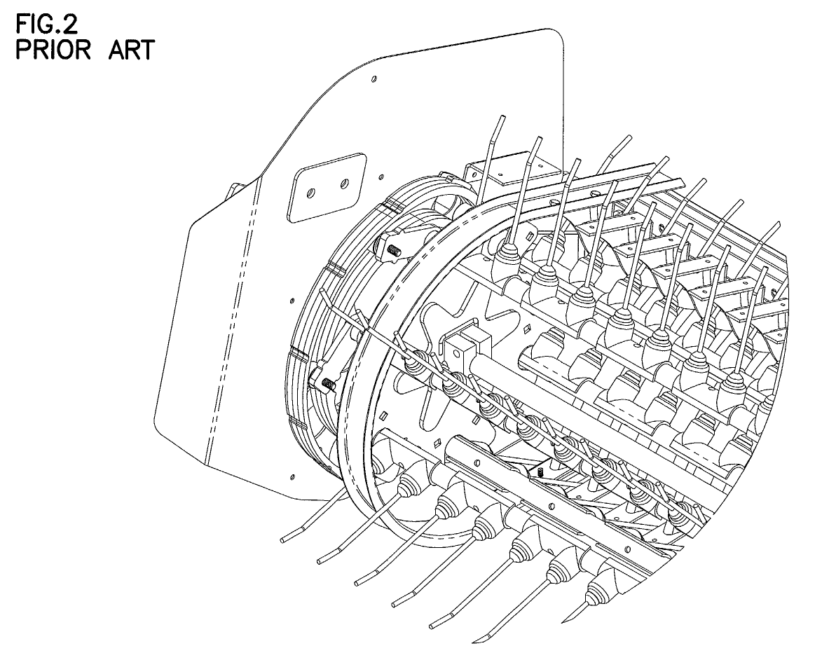

FIG. 3 is a side elevational view thereof;

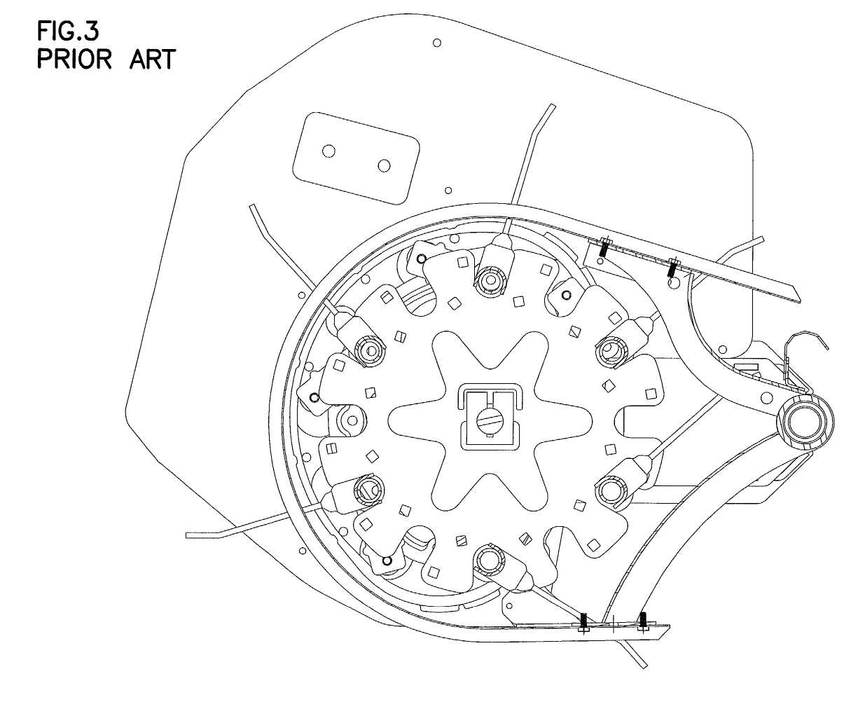

FIG. 4 is a perspective view of a crop collecting apparatus having guards according to the principles of the present invention;

FIG. 5 is a perspective view of a reel for the collecting apparatus shown in FIG. 4;

FIG. 6 is a detail perspective view of a portion the reel shown in FIG. 5 with a single guard mounted to the reel;

FIG. 7 is a detail perspective view of a portion of the reel shown in FIG. 5 with several guards mounted to the reel and several guards partially mounted to the reel;

FIG. 8 shows an end elevational view of the reel shown in FIG. 5;

FIG. 9 shows a perspective view of a guard for the crop collecting apparatus shown in FIG. 4; and

FIG. 10 shows a perspective view of the guard shown in FIG. 8 bent to a position as mounted to a reel.

### DETAILED DESCRIPTION OF THE PREFERRED EMBODIMENT

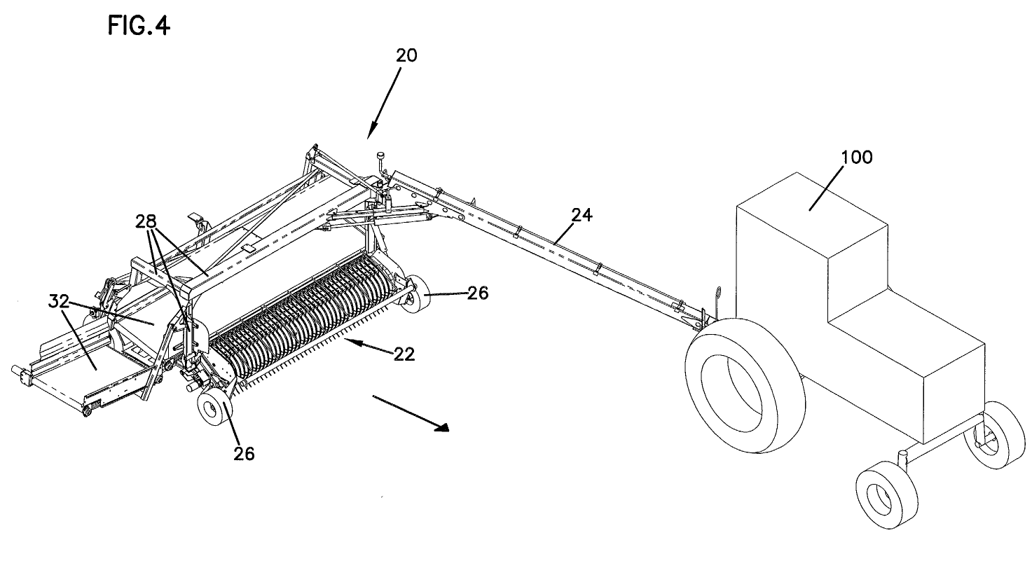

Referring now to the drawings, and in particular to FIG. 4, there is shown a crop harvester or pick up device generally designated 20. The pick up device 20 may be towed behind a tractor or other vehicle 100 using a hitch and tow bar 24, such as is well known. In addition, the pick up device may be a dedicated self-propelled vehicle, as is well known in the art. The harvester 20 may include its own power source or may be driven by a power takeoff from the towing vehicle 100, as is widely known in the art. The pick up head, generally designated 22, extends between wheels 26 and mounts on a harvester frame 28 at a leading edge. The pick up head 22 is generally oriented transverse to the general direction of travel to engage a wide swath of the crop being picked up. The pick up head 22 generally lifts the crop from the ground and delivers it rearward to a crop delivery system 32. Although conveyers are shown in FIG. 4, it can be appreciated by those skilled in the art that the crop may be directed backward to a round baler, to a square baler, to a combine storage compartment, or directed through a cutter or chopper, as well as other devices used in various steps for harvesting crops. The pick up device 20 is generally adjustable to optimize operation with regard to the type of crop, the terrain and harvesting conditions and other variables. The height and orientation may be adjusted with hydraulics and other settings on the pick up device 20, as well as adjusting the speed of the tow device 100.

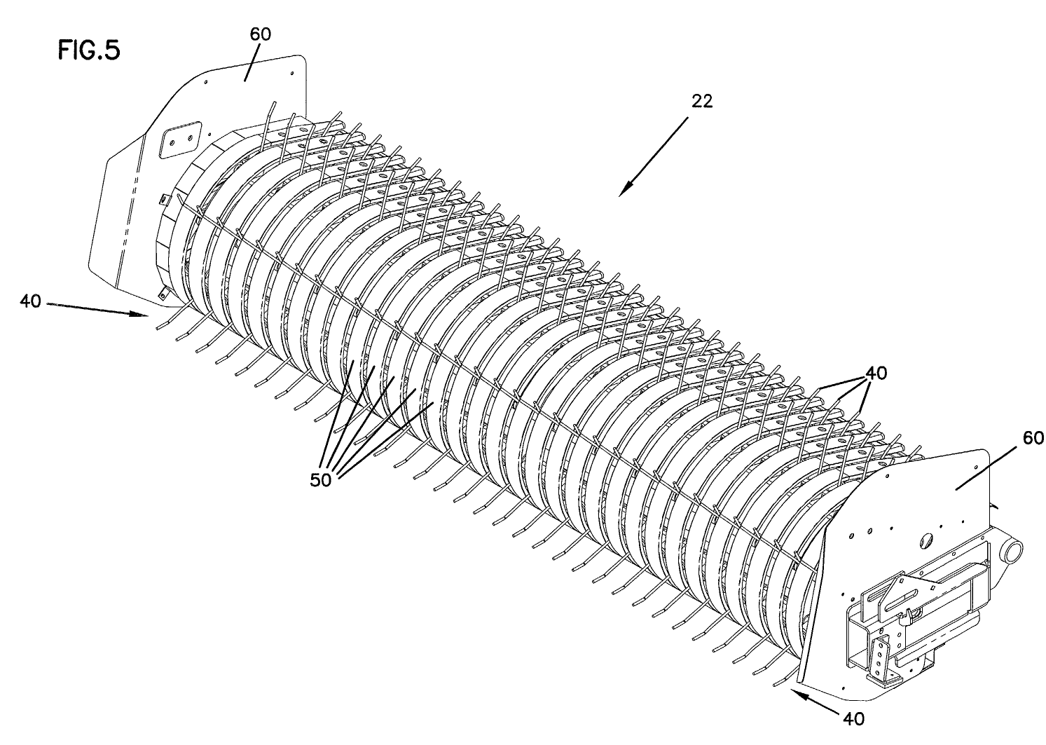

Referring now to FIG. 5, there is shown in greater detail the harvester head 22. The head includes end plates 60 at opposite ends of the head 22. A plurality of sets of tines 40 mounts on a rotating reel, as explained hereinafter. Intermediate the sets of tines 40 and axially spaced along the length of the pick up head 22 are arcing guards or strippers 50. When mounted, the guards or strippers 50 generally arc around the rotating reel so as to extend below and to the rear, arcing around the front, over the top and to the rear of the reel, attaching at both ends.

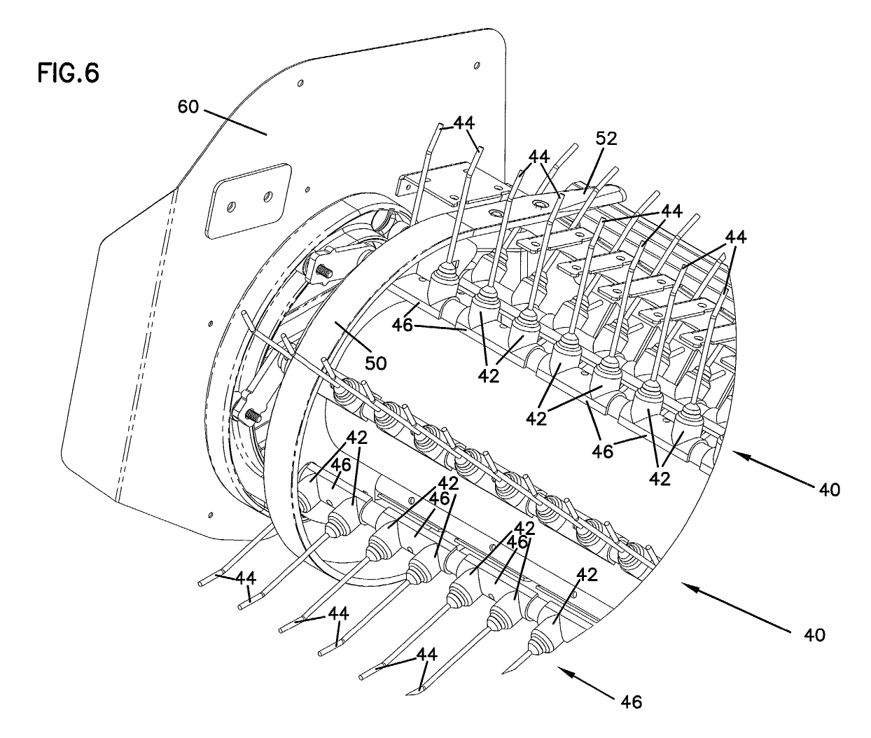

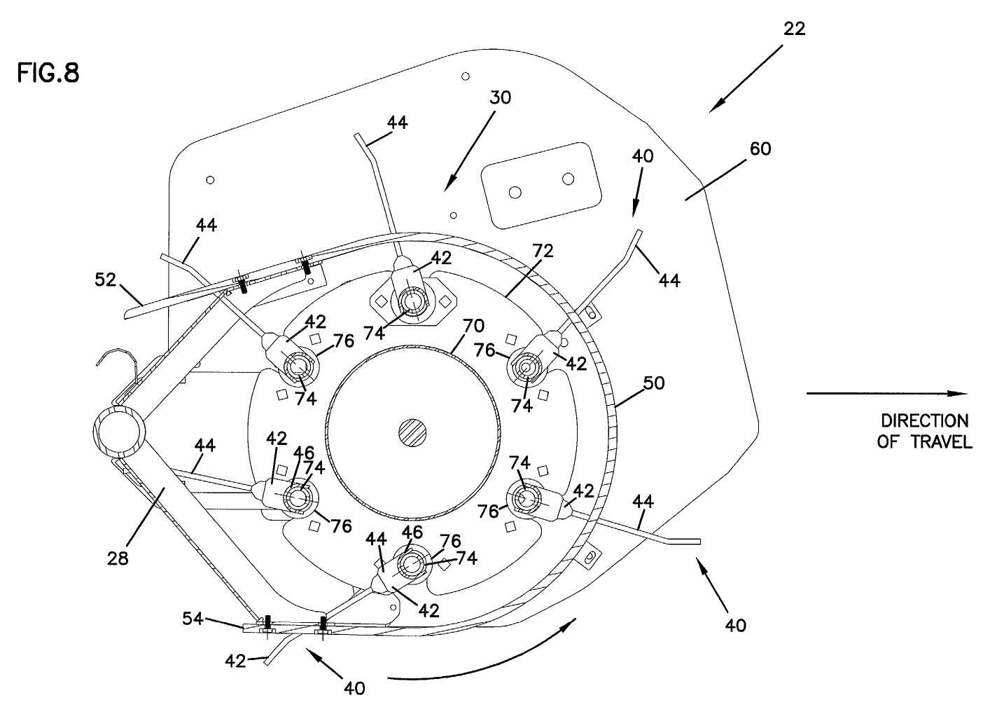

Referring now to FIGS. 6-8, there is shown additional details of the reel 30 for the head 22. The reel 30 generally rotates so that the tines 40 are moving forward and upward away from the ground in front of the reel 30 as the pick up device 20 advances, moving counter clockwise as viewed in FIG. 8. The reel 30 includes a rotating arbor 70 with two or more arbor plates 72 extending radially outward at the ends and, in some embodiments, plates 72 are also intermediate the ends of the arbor 70. The arbor plates 72 receive bars spaced circumferentially around the arbor 70. The bars 74 extend the length of the arbor 70 and mount in receiving recesses 76 formed in the arbor plates 72. The bars 74 receive pairs of tines 40 in the embodiment shown. Each tine 40 has a finger portion 44 on a base portion 42, extending downward to a shared bar mounting section 46 that wraps around a portion of the mounting bar 74. Although the tines 40 are shown mounted in pairs, it can be appreciated that the tines 40 may be mounted individually or in other numbers or in other sets, such as quadruples, triples, etc. In addition, the reel 30 is shown with six tines 40 spaced about the circumference of the reel. However, the sets of tines can include fewer or more tines, depending upon the device, the crop being harvested, the terrain and other variables that affect the design. The finger portion 44 of the tine 40 generally curves or angles forward and may include an elbow portion or may have a continuous arc along its length.

The tines 40 engage the crop and lift it from the ground or directly from the plant. The tines 40 typically are mounted with a limited degree of rotational freedom to provide extended contact with the crop and assist in optimal pick up of the crop. The tines 40 can flex or are engaged by a cam to move as they engage the ground or plant, as shown by the lowermost tine in FIG. 8, and are biased forward when disengaged from the ground. This provides additional flexure into the tines 40 and helps to propel the crop, as well as to decrease the number of tines that are bent or broken due to striking an obstruction, such as a rock or uneven terrain in the path of the pick up device 20. Moreover, other mounting configurations, different types of bars or mounting structure may also be utilized that are well known in the art.

As shown most clearly in FIGS. 5-7, guards 50 extend between the sets of tines 40 in a spaced apart relationship axially spaced along the reel 30. The guards mount below and to the rear, and above and to the rear of the arbor 70 in an arc spaced radially outwardly from the reel 30, beyond the base portions 42 of the tines 40. The guards 50 protect the internal components of the head 22 from rocks, portions of the plants that are not to be harvested, and other debris that may be encountered along the path of the pick up device 20. The guards 50 provide a multiplicity of slits spaced axially along the pick up head 22 with the finger portions 44 of the tines extending through the slits formed by adjacent guards 50 and rotating along the arcing portion of the mounted guards 50.

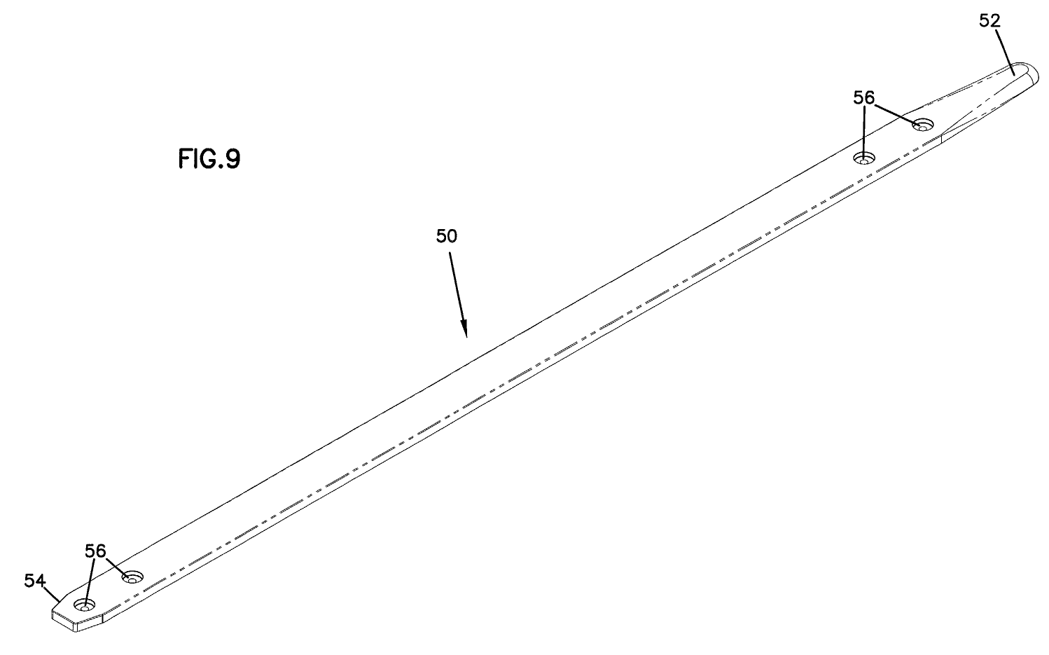

According to the present invention, the guards or strippers 50 are substantially straight elongate members, as shown in FIG. 9. The guard 50 includes a first tapered end 52 and a second end 54 having a corner portion. Mounting holes 56 provide for mounting at the top and bottom of the head 22. The mounting holes 56 are spaced apartment from the tapered end 52. The mounting holes 56 may be countersunk or counter bored to accommodate mounting hardware so that the head of the hardware is not protruding beyond the surface of the guard 50. A smooth surface provides for better operation and less likelihood of debris catching on the hardware. The guard 50 is a substantially planar plastic member in one embodiment, such as polyethylene and may be made from an ultraviolet resistant material. In one embodiment, the guards 50 are made of an ultra high molecular weight polyethylene. Such guards provide improved flexibility without damaging augers or choppers, should portions break off. A typical guard may have a length of 50 inches, with 5 and ⅝ inches of the guard forming a tapered end 52. A typical guard may have a width of 1.875 inches and a thickness of 0.375 inches. The mounting holes 56 at the tapered end 52 may be spaced apart by 3 inches and the mounting holes at the second end 54 may be spaced apart by 2.5 inches. On a 9 foot, 6 inch head, such as may be used in a typical crop harvester device, as shown in FIG. 5, thirty two guards 50 are utilized to provide a flexible shield to the inner components of the head 22.

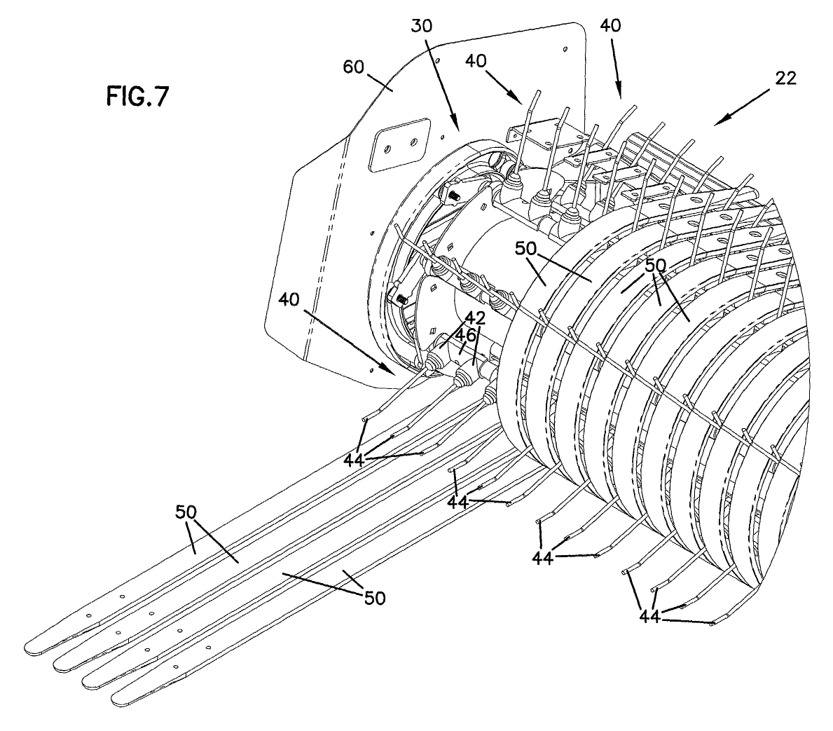

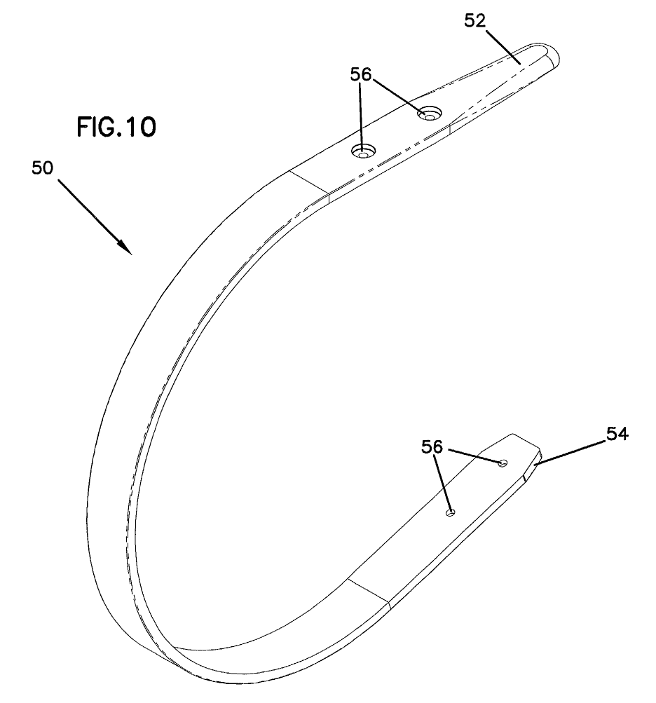

Referring to FIG. 10, although the guard 50 is bent in an arcing configuration for mounting, such as also shown in FIG. 8, the arc is only made by attaching both ends 52, 54 to the pick up device 20. Unlike prior guard-type devices that were bent into a permanent arcing configuration, and then mounted, the present invention has substantially straight guards 50 when not flexed, as shown in FIG. 9. To mount the guards 50, a first end is attached to the head 22, generally at a lower end, as shown in FIG. 7. The straight guards 50 extend outward in an unflexed state with a first end mounted. Mounting is easily completed by simply bending the tapered end 52 of the guard 50 upward into the position for mounting, such as shown in FIG. 8. When both ends of the guard 50 are mounted, the guard 54 has an arcing profile, shown most clearly in FIGS. 6, 8 and 10.

With only one end of the guards 50 mounted to the pick up head, the present invention provides for easy access to the inner components of the pick up head 22. As shown in FIG. 7, tines 40 may be easily replaced by detaching the upper end of the guards 50 and allowing the guards to remain mounted and extending forward from the head 22. It can be appreciated that maintenance of the inner components, such as removing and replacing tines may be easily accomplished with this configuration. Detaching the difficult to access lower end is not needed. When the maintenance task is finished, the guards 50 are fully remounted, as shown in FIGS. 5, 6 and 8.

As the guards 50 of the present invention are not required to hold their arcing configuration, a more resilient, lightweight material may be utilized than the prior art guard devices, which were required to hold a bent, arcing configuration. The use of straight members allows for greater flexure, resulting in less damage to the guards and tines, as the guards are less likely to be bent into the path of a rotating tine. The greater flexure also reduces the occurrence of guards being bent or broken due to encounters with uneven terrain or rocks. The substantially straight elongate design also provides for improved and easier access to the various components of the cutter head. Moreover, the guards are substantially easier to mount than the prior art pre-bent devices, which had to fit the reel assembly 30 through the gap formed by the two ends.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

We claim:

1. A guard for a crop collecting apparatus, the guard comprising:
a substantially straight elongate member having tapered ends, each end having at least one mounting orifice formed therein; wherein the elongate member is coiled in an arcing configuration when mounted and returns to a substantially straight configuration when removed.

2. A guard according to claim 1, wherein the guard is adapted for mounting under tension.

3. A guard according to claim 1, wherein the mounting orifice has a countersunk portion.

4. A guard according to claim 1, wherein the guard comprises a polyethylene member.

5. A guard according to claim 4, wherein the polyethylene member comprises ultraviolet resistant stabilizers.

6. A guard according to claim 1, wherein the elongate member includes a plurality of mounting orifices.

7. A method of mounting a guard member to a head of a crop collecting apparatus, the method comprising the steps of:
providing a substantially straight elongate guard member having mounting means at a first end and a second end;
mounting the first end to the crop collecting apparatus;
coiling the guard member in an arcuate configuration around a portion of the head;
mounting the second end to the crop collecting apparatus.

8. A mounting method according to claim 7, wherein the guard member is mounted under tension.

9. A mounting method according to claim 8, wherein the mounting means comprise ends with orifices formed therein.

10. A crop collection apparatus, comprising;
a frame;
wheels mounted to the frame;
a pick up head supported on the frame and having a rotatable reel;
a plurality of tines mounted to the reel;
a housing extending around the reel, including a plurality of guards, wherein the guards are intermediate adjacent tines and alternate with the tines, and wherein the guards comprise substantially straight elongate members.

11. A crop collection apparatus according to claim 10, wherein the guards are under tension when mounted.

12. A crop collection apparatus according to claim 10, wherein the elongate members include mounting orifices with countersunk portions.

13. A crop collection apparatus according to claim 9, wherein the elongate members comprise polyethylene.

14. A crop collection apparatus according to claim 13, wherein the elongate members comprise an ultraviolet resistant material.

15. A crop collection apparatus according to claim 13, wherein the elongate members comprise ultra-high molecular weight polyethylene.

16. A crop collection apparatus according to claim 10, wherein the elongate members includes a plurality of mounting orifices.

17. A method for accessing a crop collection reel, the reel having at least one guard mounted at a first end and a second end in a flexed condition arcing around a portion of the reel under tension, the method comprising the steps of:
detaching only the first end of the guard and releasing the first end of the guard, wherein the guard returns to a straight configuration upon release of the first end, pulling the guard from around the axle and extending outward from the attached second end.

18. A crop collecting reel for mounting to a crop collection apparatus, the reel comprising:
an arbor;
a plurality of tines, including tine sets having tines spaced apart radially around the arbor, wherein the tine sets are axially spaced along the arbor;
a housing comprising a plurality of substantially straight elongate guards intermediate adjacent tine sets, wherein the guards are configured for mounting to the crop collection apparatus in an arcing configuration.
